(19) United States
(12) Patent Application Publication
(10) Pub. No.: US 2026/0123603 A1
(43) Pub. Date: May 7, 2026

(54) TAMPER-RESISTANT WILDLIFE FEEDER

(71) Applicant: Russell David Thompson, Dickerson, MD (US)

(72) Inventor: Russell David Thompson, Dickerson, MD (US)

(21) Appl. No.: 19/379,292

(22) Filed: Nov. 4, 2025

Related U.S. Application Data
(60) Provisional application No. 63/716,888, filed on Nov. 6, 2024.

(51) Int. Cl. A01K 5/02

(52) U.S. Cl. CPC A01K 5/0258; A01K 5/0291

(57) ABSTRACT

A tamper-resistant wildlife feeder includes a base housing, anchor means for anchoring the base housing to a surface supporting the wildlife feeder, a feed hopper for storing a supply of flowable wildlife feed, wherein the feed hopper is supported on the base housing and includes a feed egress aperture at a bottom end of the feed hopper, securing means for securing the feed hopper to an immovable object in close proximity to the wildlife feeder, and a feed dispense system. The feed dispense system includes a feed conveyor tube disposed within the base housing and having feed ingress aperture positioned with respect to the feed egress aperture of the feed hopper to allow flowable wildlife feed to flow from the feed hopper into the feed conveyor tube and terminating at a feed dispense opening formed in a wall of the base housing.

### CROSS REFERENCE TO RELATED APPLICATION

This application claims the benefit under 35 U.S.C. § 119(e) of the filing date of U.S. provisional patent application Ser. No. 63/716,888 filed Nov. 6, 2024, the disclosure of which is incorporated herein by reference.

### FIELD OF THE INVENTION

The present invention relates to a wildlife feeder for feeding and attracting wildlife in the wild that uses a feed storage hopper, a dispense system, and a base housing to hold, distribute, and present feed in a manner that is tamper-resistant.

### BACKGROUND OF THE INVENTION

Hunters, trappers, and wildlife enthusiasts use feed to attract wildlife, including deer, elk, moose, bison, wild boar, and more. Traditionally, feed is scattered on the ground to attract said game, which requires frequent re-application of the feed and repeat visits to the site of the feeder, which is often remote. Automated feeders exist, but involve technical and logistical complexities, including vulnerabilities to tampering by large animals, such as bears, which can be attracted by the stored feed and can aggressively, and often destructively, seek access to the feed stored in the feeder, removing the feed and often damaging or permanently disabling the feeder. Further issues can arise from small animals, e.g., small rodents, such as mice and chipmunks, which can be small enough to enter feeders and consume the stored feed, or otherwise disrupt the normal functioning of the feeder. In addition, unattended wildlife feeders may be vulnerable to human vandals. Thus, a need exists for a tamper-resistant feeder that can automatically, reliably and efficiently disperse feed.

### SUMMARY OF THE INVENTION

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

Aspects of the invention are embodied in a tamper-resistant wildlife feeder for safely feeding and attracting game in the wild that comprises a feed hopper, a dispense system, and a ground-anchored base housing.

A wild game feeder for safely and quietly attracting and feeding game that is tamper-resistant includes a feeder unit including a feed storage hopper, a feed dispense system, and an anchored base/housing. The feed storage hopper holds feed for wild game and has a funnel shaped floor leading to a feed egress aperture in the bottom of the hopper. The feed storage hopper has a tamper proof lid requiring hand tools or battery powered impact gun or similar device for removal. A toolless lid—i.e., not requiring tools for removal—maybe used in applications where there is no concern for the lid being removed unintentionally. The feed storage hopper may be securely attached to the anchored base/housing and may be additionally attached to a tree, post or other immovable object when installed in the field.

The dispensing system comprises a feed conveyor tube, auger, and a slow rotation speed motor coupled to the auger, wherein the motor is controlled by a programmable controller and powered by a battery or other power source, which may be a portable power source.

The feed conveyor tube is round and comprises a drive end through which the auger extends to the motor, feed ingress aperture, and a feed discharge, or dispense, end. The feed conveyor tube is attached inside of the anchored base/housing and may be horizontally located inside the ground anchored base/housing, located beneath the feed storage container with the feed ingress aperture located slightly forward of the drive end. The feed conveyor tube may slope downward toward the feed dispense end thereby employing gravity to assist with feed flow.

When feed falls through the aperture at the bottom of the feed storage hopper, it enters the feed conveyor tube and collects inside the feed conveyor tube and around the auger. The auger comprises an axis and a series of flights that spiral around the axis. The auger may be smaller (e.g., about 33% smaller) than the conveyor tube and is affixed within the central axis of the conveyor tube at both the drive end and the dispense end of the tube. The feed conveyor tube, feed input aperture, auger, and discharge end auger support may be shaped and sized to eliminate or limit all shearing, grinding, binding, and friction caused by contact between the auger flights and the feed conveyor tube inner walls. Sufficient space around the auger avoids or reduces interference or friction that might otherwise be caused by feed binding between the flights of the auger and the inside walls of the feed conveyor tube. When stationary, the auger obstructs the gravity flow of feed so that feed does not come out the dispense end unless the auger is rotating.

The slow rotation speed motor is attached to the drive end axis of the auger and rotates the auger when activated.

The controller and battery are located inside of the anchored base/housing. The controller is programmable, is connected to the slow rotation speed motor, and controls when the slow rotation speed motor is activated.

The base/housing has a removable panel on one side to access the auger, battery, controller, and drive motor. All components are easily replaceable in the field.

When the motor is activated, the auger turns, assisting the flow of feed from the feed storage hopper to the dispense end of the feed conveyor tube.

When discharged feed falls from behind a small animal restrictor covering the dispense end of the feed conveyor tube, the feed slides down a sloped feed presentation plate at a front of the anchored base/housing below the dispense end. Recessed or raised riffles on the presentation plate capture and visually display a portion of the feed dispensed as a visual attraction to wildlife as well as a visual confirmation of operation for cellular surveillance equipment (e.g., trail cameras) to capture.

When installed, the anchored base/housing may be secured at a front side of the feed presentation plate to an anchor beam, e.g., a landscape timber, which may be secured to the ground by means of diagonally driven stakes extending, e.g., 12 inches, into the ground, at each end of the anchor beam.

The power source may comprise a battery which may be connected to a solar cell capable of recharging the battery to ensure the controller and motor has sufficient and continuous power to operate.

The battery and controller may be located inside the feed storage hopper (e.g., a top portion) for easier access.

The wild game feeder may include a secondary feed presentation plate with sideboards attached to the landscape timber below the primary feed presentation plate, to capture all discharged feed and retain it off the ground for consumption in areas with soil borne disease such as Chronic Wasting Disease in deer.

The wild game feeder, when installed in an open field setting with no trees to secure the feed storage hopper, may instead be attached to a fence post and may be secured by clamps, screws or steel straps.

In some embodiments, the feeder comprises a base housing. In some embodiments, the base housing comprises anchor means operable with the base housing for anchoring the base housing to a surface supporting the wildlife feeder, wherein the feed hopper is supported on the base housing and includes a feed egress aperture at a bottom end of the feed hopper. The anchor means may be, for example, stakes, clamps, screws, or steel straps. In some embodiments, the base housing is anchored to a surface supporting the wildlife feeder, which is a landscape timber, optionally by means of diagonally driven stake extending at least about 12 inches into the ground at each end.

In some embodiments, the feeder comprises a feed hopper for storing a supply of flowable wildlife feed (e.g., corn, oats, beans, pellets, etc.), and is supported on the base housing. The feed hopper comprises a feed egress aperture at a bottom end of the feed hopper. In some embodiments, the hopper comprises a funnel-shaped floor terminating in said feed egress aperture.

In some embodiments, the feeder comprises securing means for securing the feed hopper to an immovable object in close proximity to the wildlife feeder.

In some embodiments, the feeder comprises a dispense system. In some embodiments, the dispense system comprises a feed conveyor tube disposed within the base housing and having feed ingress aperture positioned, in some embodiments, with respect to the feed egress aperture of the feed hopper to allow flowable wildlife feed to flow from the feed hopper into the feed conveyor tube. In some embodiments, the feed conveyor tube terminates at a feed dispense opening formed in a wall of the base housing.

In some embodiments, the dispense system comprises a motorized, rotating auger. In some embodiments, the auger is disposed within the feed conveyer tube. The auger is configured to convey feed within the feed conveyor tube from the feed ingress aperture to the feed dispense opening. In some embodiments, the auger is driven by a conveyor motor, which may be a slow rotation drive motor. In some embodiments, the conveyor motor is powered by a battery. In some embodiments, the conveyor motor is operated by a programmable timer. In some embodiments, said timer is operable to be programmed with a feeding schedule.

In some embodiments, the feeder comprises a feed presentation plate positioned to receive feed dispensed from the feed dispense opening. In some embodiments, the presentation plate is configured to hold at least a portion of the dispensed feed in a manner to enable wildlife to eat the feed supported on the feed presentation plate. In some embodiments, the presentation plate comprises recessed or raised riffles or edges. In some embodiments, the presentation plate comprises sideboards to restrict or direct the movement of feed. In some embodiments, the feeder comprises a secondary plate, optionally positioned to capture all excess discharged feed and prevent it from falling onto the ground.

In some embodiments, the feeder comprises a small animal restrictor positioned over the feed dispense opening. In some embodiments, the restrictor is configured to restrict small animal access to the feed dispense opening and the feed conveyor tube.

Implementations of the disclosure can be described in view of the following embodiments, the features of which can be combined in any reasonable manner.

Some embodiments encompass:

Embodiment 1. A tamper-resistant wildlife feeder comprising: a base housing; anchor means operable with the base housing for anchoring the base housing to a surface supporting the wildlife feeder; a feed hopper for storing a supply of flowable wildlife feed, wherein the feed hopper is supported on the base housing and includes a feed egress aperture at a bottom end of the feed hopper; securing means for securing the feed hopper to an immovable object in close proximity to the wildlife feeder; a feed dispense system comprising: a feed conveyor tube disposed within the base housing and having feed ingress aperture positioned with respect to the feed egress aperture of the feed hopper to allow flowable wildlife feed to flow from the feed hopper into the feed conveyor tube, wherein the feed conveyor tube terminates at a feed dispense opening formed in a wall of the base housing; and an auger disposed within the feed conveyor tube and configured to convey feed within the feed conveyor tube from the feed ingress aperture to the feed dispense opening; a feed presentation plate positioned to receive feed dispensed from the feed dispense opening and configured to hold at least a portion of the dispensed feed in a manner to enable wildlife to eat the feed supported on the feed presentation plate; and a small animal restrictor positioned over the feed dispense opening and configured to restrict small animal access to the feed dispense opening and the feed conveyor tube.

Embodiment 2. The wildlife feeder of embodiment 1, wherein the feed hopper comprises a funnel-shaped floor terminating in said feed egress aperture.

Embodiment 3. The wildlife feeder of embodiment 1 or embodiment 2, wherein the feed presentation plate comprises a raised riffle and/or grooves or slots formed in a top surface thereof.

Embodiment 4. The wildlife feeder of any one of embodiments 1-3, further comprising a secondary feed presentation plate disposed with respect to the feed presentation plate to receive feed flowing from the feed presentation plate.

Embodiment 5. The wildlife feeder of embodiment 4, comprising side walls and a raised riffle secured to the secondary plate to form a catch box to capture discharged feed.

Embodiment 6. The wildlife feeder of any one of embodiments 1-5, wherein the immovable object is a tree, fence post, utility pole, or metal post.

Embodiment 7. The wildlife feeder of any one of embodiments 1-6, wherein the securing means comprise clamps, screws, and/or steel straps.

Embodiment 8. The wildlife feeder of any one of embodiments 1-7, wherein the feed dispense system further comprises a conveyor motor connected to a power source and coupled to the auger so that the auger is driven by the conveyer motor.

Embodiment 9. The wildlife feeder of embodiment 8, wherein the feed dispense system further comprises a programmable controller in communication with the conveyor motor and programmed to activate the conveyor motor at programmed time intervals.

Embodiment 10. The wildlife feeder of embodiment 8 or embodiment 9, wherein the power source comprises a battery.

Embodiment 11. The wildlife feeder of any one of embodiments 1-10, wherein the auger has a diameter that is less than a width of the feed conveyor tube.

Embodiment 12. The wildlife feeder of embodiment 11, wherein the auger diameter is about 33% smaller than a diameter of the feed conveyer tube.

Embodiment 13. The wildlife feeder of embodiment 11 or 12, wherein the auger is substantially centered in the feed conveyor tube so there is no contact between a blade of the auger and an inside surface of the feed conveyor tube.

Embodiment 14. The wildlife feeder of any one of embodiments 1-13, wherein the anchor means comprises one or more stakes extending through a portion of the base housing or through an anchor beam to which the base housing is attached and into the surface supporting the wildlife feeder and/or one or more weights positioned on a portion of the base housing and/or the feed hopper.

Embodiment 15. The wildlife feeder of any one of embodiments 1-14, wherein the feed presentation plate is angled.

Embodiment 16. The wildlife feeder of any one of embodiments 1-15, wherein the small animal restrictor comprises a plate secured to the wall of the base housing in a position over the feed dispense opening.

Embodiment 17. The wildlife feeder of embodiment 16, wherein one edge of the plate of the small animal restrictor is in contact with the wall to which the plate is secured and an opposite edge of the plate is spaced apart from the wall.

Embodiment 18. The wildlife feeder of embodiment 5 comprising one or more divider walls mounted within the catch box to form one or more secondary feed compartments within the catch box.

Embodiment 19. The wildlife feeder of any one of embodiments 1-18, further comprising: a lid disposed on the hopper; and a ring clamp securing the lid to the hopper.

Embodiment 20. The wildlife feeder of any one of embodiments 1-19, further comprising a top cover extending from the base housing at a position above the feed dispense opening.

Other features and characteristics of the subject matter of this disclosure, as well as the methods of operation, functions of related elements of structure and the combination of parts, and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

The accompanying drawings, which are incorporated herein and form part of the disclosure, help illustrate various embodiments of the present invention and, together with the description, further serve to describe the invention to enable a person skilled in the pertinent art to make and use the embodiments disclosed herein.

FIG. 1 is a front perspective view of the wildlife feeder depicting the feed hopper atop the base and the feed dispense opening covered by the small animal restrictor, the presentation plate, and a secondary feed presentation plate.

FIG. 2 is a partial, schematic cross-section of an embodiment of the wildlife feeder.

FIG. 3 is an internal view of a base housing of the wildlife feeder, depicting a feed conveyer tube and an auger shaft extending into the conveyor tube.

FIG. 4 is a front-view of the wildlife feeder, depicting a feed discharge end of the feed conveyer tube terminating in the feed egress aperture, the auger, auger shaft, and auger blade, and auger shaft end support of the housing.

FIG. 5 is a partial side perspective view of the wildlife feeder, depicting a feed discharge covered by the small animal restrictor.

FIG. 6 is a partial side perspective view of the wildlife feeder, depicting the feed discharge covered by the small animal restrictor.

FIG. 7 is a partial side perspective view of the wildlife feeder, depicting the feed discharge end and auger shaft end support of the ground anchored base housing, as covered by the small animal restrictor and fastener, and adjacent feed presentation plate.

FIG. 8 is a front-view of the wildlife feeder, depicting feed emerging from a feed egress aperture covered by a small animal restrictor and with discharged feed collecting on a feed presentation plate.

FIG. 9 is a partial top perspective view showing an embodiment of the wildlife feeder including a feed hopper with a lid affixed by a clasp.

FIG. 10 is a partial internal view of the feed hopper, depicting the funnel-shaped floor terminating in the feed hopper egress aperture and anchor bolts for anchoring the feed hopper to an adjacent structure.

FIG. 11 is a partial side perspective view of the wildlife feeder, depicting the base anchored to a supporting surface, by means of diagonally driven ground stake.

FIG. 12 is a partial front perspective view of the wildlife feeder, depicting the base, and the feed dispense opening covered by the small animal restrictor, and the feed presentation plate.

FIG. 13 is a front perspective view of an alternate configuration of the wildlife feeder.

FIG. 14 is a front perspective view of a second alternate configuration of the wildlife feeder.

### DETAILED DESCRIPTION OF THE INVENTION

Unless defined otherwise, all terms of art, notations and other technical terms or terminology used herein have the same meaning as is commonly understood by one of ordinary skill in the art to which this disclosure belongs. All patents, applications, published applications and other publications referred to herein are incorporated by reference in their entirety. If a definition set forth in this section is contrary to or otherwise inconsistent with a definition set forth in the patents, applications, published applications, and other publications that are herein incorporated by reference, the definition set forth in this section prevails over the definition that is incorporated herein by reference.

Note that as used herein, the singular forms “a,” “an,” and “the” include plural referents unless the context clearly dictates otherwise.

References in the specification to “one embodiment,” “an embodiment,” a “further embodiment,” “an example,” “an exemplary embodiment,” “some aspects,” “a further aspect,” “aspects,” etc., indicate that the embodiment, example, or aspect described may include a particular feature, structure, or characteristic, but every embodiment encompassed by this disclosure may not necessarily include the particular feature, structure, or characteristic or combination thereof. Moreover, such phrases are not necessarily referring to the same embodiment, example, or aspect. Further, when a particular feature, structure, or characteristic is described in connection with an embodiment, such feature, structure, or characteristic is also a description in connection with other embodiments, examples, or aspects with which it is not incompatible, whether or not explicitly described.

As used herein, the term “immovable” refers to an object, structure, or fixture that is fixed in place and cannot be readily moved, i.e., is resistant to being picked up, tipped over, or otherwise moved or dislodged by persons or animals without the use of tools, equipment, or specialized machinery. The term encompasses, but is not limited to, items such as trees, fence posts, utility poles, buildings, and other structures that are secured or anchored to or into the ground or any other surface in a manner that resists movement. As used herein, “immovable” may include objects that are anchored, embedded, or otherwise affixed to a surface so that they maintain a fixed position relative to their point of attachment or placement.

This description may use various terms describing relative spatial arrangements and/or orientations or directions in describing the position and/or orientation of a component, apparatus, location, feature, or a portion thereof or direction of movement, force, or other dynamic action. Unless specifically stated, or otherwise dictated by the context of the description, such terms, including, without limitation, top, bottom, above, below, under, on top of, upper, lower, left, right, in front of, behind, beneath, next to, adjacent, between, horizontal, vertical, diagonal, longitudinal, transverse, radial, axial, clockwise, counter-clockwise, forward, backward, sideward, sideways, etc., are used for convenience in referring to such component, apparatus, location, feature, or a portion thereof or movement, force, or other dynamic action represented in the drawings and are not intended to be limiting.

Unless otherwise indicated, or the context suggests otherwise, terms used herein to describe a physical and/or spatial relationship between a first component, structure, or portion thereof and a second component, structure, or portion thereof, such as, attached, connected, fixed, joined, linked, coupled, or similar terms or variations of such terms, shall encompass both a direct relationship in which the first component, structure, or portion thereof is in direct contact with the second component, structure, or portion thereof or there are one or more intervening components, structures, or portions thereof between the first component, structure, or portion thereof and the second component, structure, or portion thereof.

Furthermore, and unless otherwise stated, any specific dimensions mentioned in this description are merely representative of an exemplary implementation of a device embodying aspects of the invention and are not intended to be limiting.

To the extent used herein, the terms “about” or “approximately” apply to all numeric values and terms indicating specific physical orientations or relationships such as horizontal, vertical, parallel, perpendicular, concentric, or similar terms, specified herein, whether or not explicitly indicated. This term generally refers to a range of numbers, orientations, and relationships that one of ordinary skill in the art would consider as a reasonable amount of deviation to the recited numeric values, orientations, and relationships (i.e., having the equivalent function or result) in the context of the present disclosure. For example, and not intended to be limiting, this term can be construed as including a deviation of ±10 percent of the given numeric value, orientation, or relationship, provided such a deviation does not alter the end function or result of the stated value, orientation, or relationship. Therefore, under some circumstances as would be appreciated by one of ordinary skill in the art a value of about or approximately 1% can be construed to be a range from 0.9% to 1.1%.

To the extent used herein, the terms “substantially” and “substantial” refer to a considerable degree or extent. When used in conjunction with, for example, an event, circumstance, characteristic, or property, the terms can refer to instances in which the event, circumstance, characteristic, or property occurs precisely as stated as well as instances in which the event, circumstance, characteristic, or property occurs to a close approximation, such as accounting for typical tolerance levels or variability of the embodiments described herein.

To the extent used herein, the terms “optional” and “optionally” or the term “may” (e.g., as in the phrase “may include,” “may comprise,” “may produce,” “may provide,” or similar phrases) mean that the subsequently described, component, structure, element, event, circumstance, characteristic, property, etc. may or may not be included or occur and that the description includes instances where the component, structure, element, event, circumstance, characteristic, property, etc. is included or occurs and instances in which it is not or does not.

To the extent used herein, the terms “first” and “second” preceding the name of an element (e.g., a component, apparatus, location, feature, or a portion thereof or a direction of movement, force, or other dynamic action) are used for identification purposes to distinguish between similar elements, and are not intended to necessarily imply order, nor are the terms “first” and “second” intended to preclude the inclusion of additional similar elements. Furthermore, use of the term “first” preceding the name of an element (e.g., a component, apparatus, location, feature, or a portion thereof or a direction of movement, force, or other dynamic action) does not necessarily imply or require that there be additional, e.g., “second,” “third,” etc., such element(s).

To the extent used herein, the terms or phrases “configured to,” “adapted to,” “operable to,” “constructed and arranged to,” and similar terms mean that the subject of the term or phrase includes, constitutes, or otherwise encompasses the requisite structure(s), mechanism(s), arrangement(s), component(s), material(s), algorithm(s), circuit(s), programming, etc. to perform a specified function, task, or tasks or achieve a specified output or characteristic, either automatically or perpetually or selectively when called upon to do so.

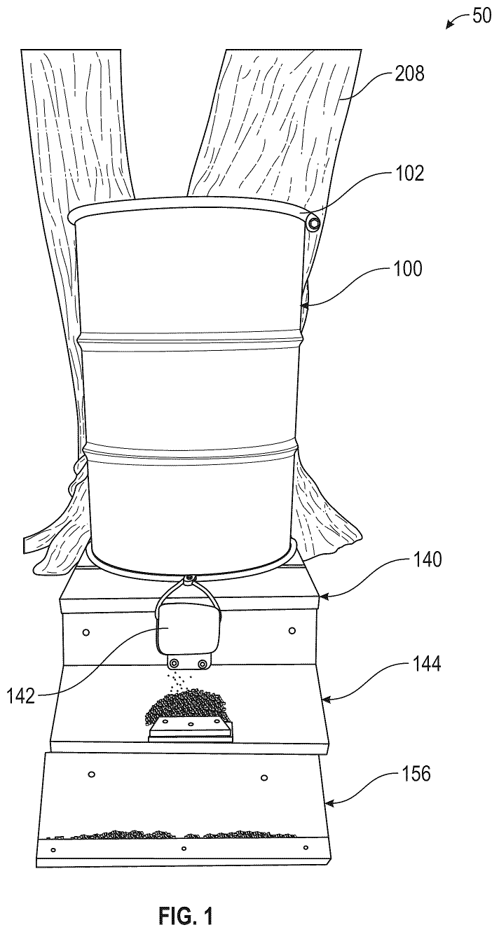

The present disclosure is of a tamper-resistant wildlife feeder 50 for feeding wildlife in the wild, as shown in FIGS. 1, 2 and 3. The wildlife feeder 50 may include a feed storage container (or hopper) 100, a base housing 140 on which the hopper 100 is supported and which may be anchored to the ground as described herein, and a feed dispense system 170 housed within the base housing 140.

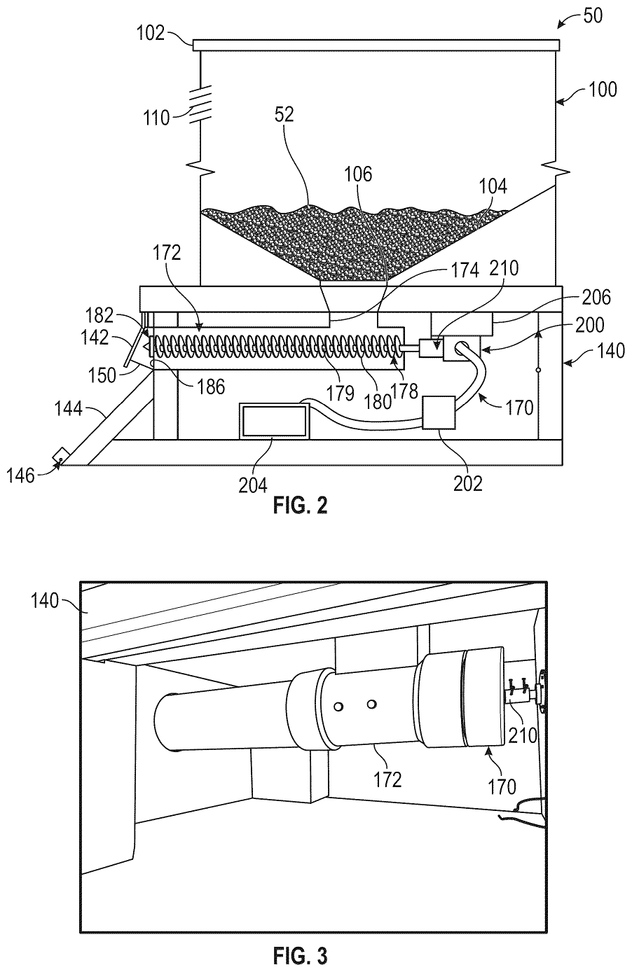

The feed hopper 100 may sit atop of and be supported on the base housing 140, as shown in FIGS. 1 and 2. The feed hopper 100 is capable of holding a flowable feed 52 for wildlife, such as corn, oats, beans, pellets, etc. The feed hopper 100 may comprise a lid 102 atop the feed hopper 100 to protect the contents from the elements. As shown in FIG. 9, the lid 102 may be securable to the hopper 100 via a ring clamp 108 held in place by a secure fastener, such as a bolt, thereby requiring tools to remove the ring clamp 108 to remove the lid 102 from hopper 100. The lid 102 may otherwise be securable via a lock, hook, or another mechanism to affix the lid 102 to the hopper 100. As shown in FIG. 2, hopper 100 may include a louver 110 or other ventilation to avoid excessive moisture accumulation in inside the hopper.

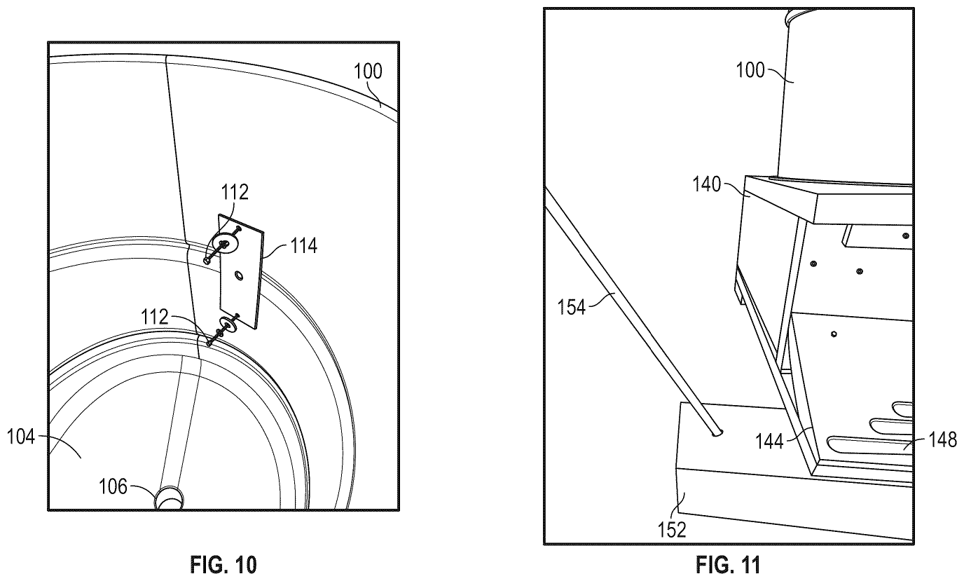

In some embodiments, and as shown in FIGS. 2 and 10, the feed hopper 100 may comprise a substantially funnel-shaped floor 104, such that the floor slopes inwardly from the outer periphery of the hopper so that the funnel-shaped floor 104 directs the feed 52 downwards. The floor 104 further compromises a feed egress aperture 106 at the lowest point of the floor 104. The feed egress aperture 106 is sized so that feed 52 may pass through the aperture 106, from said feed hopper 100 and into the feed dispense system 170 located within the base housing 140 as described herein. The aperture 106 may vary in size depending on the desired flow rate of the feed 52 and the nature of the feed material. The funnel shape of the floor 104 ensures that all, or substantially all, feed 52 within the container 100 is directed towards the aperture 106 with minimal feed 52 residue remaining on the surface of the floor 104.

Feeder 50 may include securing means for securing the feed hopper 100 to an immovable object 208 in close proximity to the feeder, such as a tree or a post. In one example, as shown in FIG. 10, feed hopper 100 may be anchored to an immovable object, e.g., a tree or anchored post, by one or more fasteners 112, e.g., screw, lag bolt, etc., extending through a wall of the hopper 100 into the immovable object, and for which purpose a reinforcing plate 114 may be provided. In one example, the fasteners 112 may comprise 6″ or 8″ Timberlok screws paired with large fender washers or steel plate 114. A spacer (not shown) may be placed between the immovable object and the feed storage hopper prior to attachment to the tree to allow adequate space for the removal of the lid. In another example, feed hopper 100 may be secured to an immovable object by one or more strong bands (not shown), made from, e.g., steel or high-strength nylon or similar material.

Alternatively, the feed hopper 100 may be attached to the immovable structure 208 via a plurality of mounting brackets (not shown) that are integrally formed with or affixed to the exterior surface of the hopper 100. The feed hopper 100 may be attached to the immovable structure via fastening elements which may be configured to penetrate or encircle the immovable object, providing a secure, stable attachment that resists displacement or detachment. The securing means may include attachment mechanisms such as adjustable clamps, bands, or other securing devices that are capable of conforming to various shapes and sizes of immovable objects, thereby allowing the hopper 100 to be affixed to a wide range of immovable objects. Different attachment mechanisms may be used in combination. The attachment mechanisms may further include cushioning elements, such as rubber pads or spacers, positioned between the hopper 100 and the immovable object 208 to prevent damage to either the hopper 100 or the immovable object 208 and to provide additional stability during use.

As shown in FIGS. 1, 2, 7 and 12 base housing 140 may include one or more of a small animal restrictor 142 and/or a feed presentation plate 144, described below.

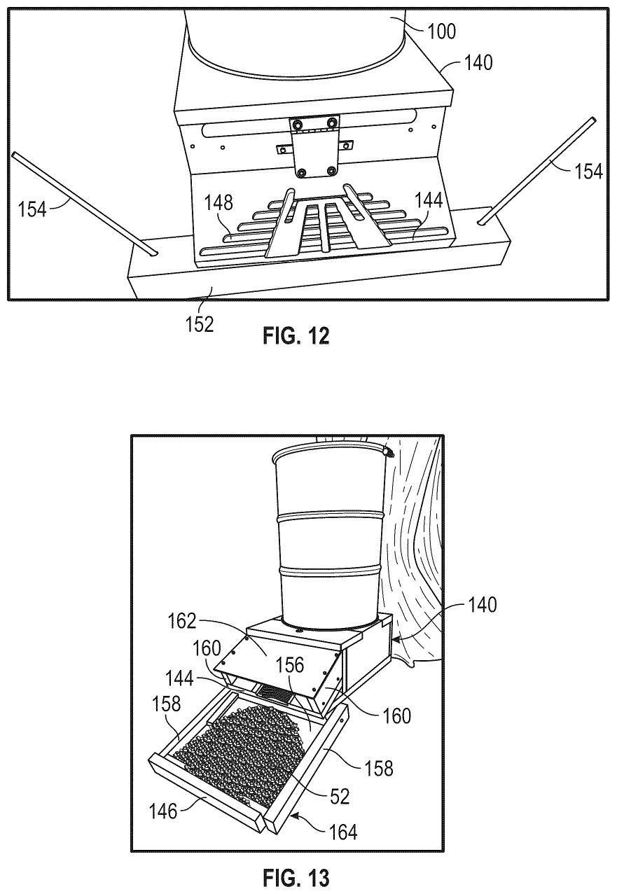

Wildlife feeder 50 preferably includes means operable with the base housing 140 for anchoring the base housing 140 to a surface supporting the wildlife feeder 50. For example, as shown in FIGS. 11 and 12, base housing 140 may include, or be affixed to, an anchor beam 152, such as a landscape timber. As shown in FIGS. 11 and 12, the anchor beam 152 may be secured to the ground by means of diagonally driven stake 154 driven through each end of anchor beam 152 so as to resist movement of the base housing 140 secured to the anchor beam 152. Each stake 154 may extend at least about 3 inches, about 6 inches, about 8 inches, about 12 inches, about 18 inches, or more into the ground, depending on the density and compactness of the ground, at each end to secure the anchor beam 152. Anchor beam 152 may be secured to the ground by other elongated fasteners. The fasteners may be made from steel (e.g., a steel rod, such as a length of concrete reinforcing bar, or rebar) or other durable material capable of withstanding outdoor conditions. Although two stakes 154 are shown in the drawings, more or less than two stakes 154 may be used. One or more stakes 154 may alternatively or additionally be driven into the ground directly through a portion of the base housing 140.

In other examples, base housing 140 may be anchored by one or more heavy weights placed on the housing.

As shown in FIGS. 2-4, dispense system 170 may comprise a feed conveyer tube 172 through which feed 52 may pass. Tube 172 is positioned within the base housing 140 and has a feed ingress aperture 174 positioned with respect to the feed egress aperture 106 of the hopper 100 to allow flowable wildlife feed 52 to flow from the feed hopper 100 into the feed conveyer tube 172. Feed conveyor tube 172 terminates at a dispense opening 186 formed in a wall of the base housing 140.

In some embodiments, the tube 172 is defined by a substantially circular cross-section and is fabricated from a durable material, such as metal or high-strength plastic, such as PVC (polyvinylchloride). The interior surface of the tube 172 may be smooth to reduce resistance via friction as the feed 52 is conveyed along its length.

In some embodiments, the feed conveyor tube 172 may be attached to and horizontally located inside of the ground-anchored base 140. The length of the feed conveyer tube 172 may be less than the length of the ground-anchored base 140. In some embodiments, at least the feed ingress aperture 174 of the feed conveyor tube 172 may be positioned beneath the feed hopper 100, such that feed 52 from the hopper 100 may pass through the egress aperture 106 at the base of the funnel-shaped floor 104 of the feed hopper 100 and directly through the feed ingress aperture 174 of the feed conveyer tube 172. The feed conveyor tube 172 may slope downward toward the feed dispense opening 186, thereby employing gravity to assist with flow of the feed 52 towards the feed dispense opening 186.

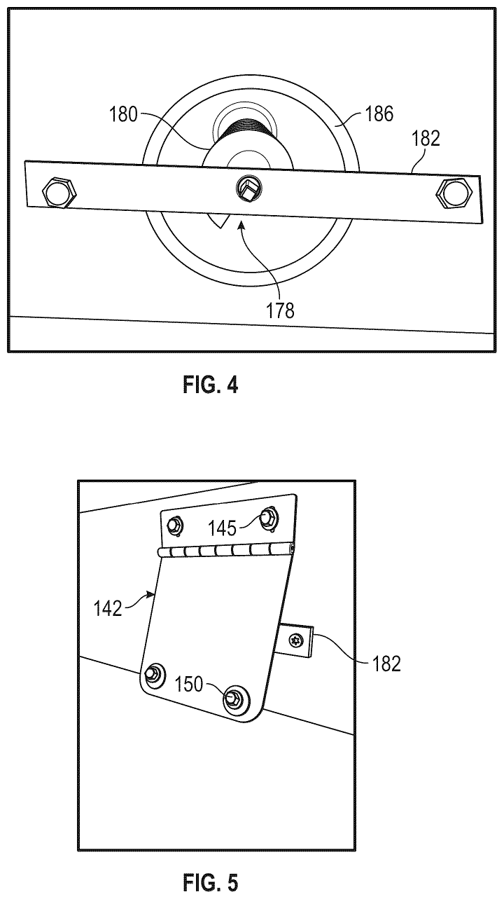

As shown in FIG. 2, dispense system 170 may comprise a motorized, rotating auger 178 disposed within feed conveyer tube 172. As shown in FIGS. 2 and 4, the auger 178 is coaxially aligned with a longitudinal axis of the feed conveyor tube 172. The auger 178 comprises a central shaft 179 and a helical blade 180 extending outwardly from the shaft. The blade 180 may be configured to rotate about the central axis of the shaft to convey feed material along the length of the tube 172 when the auger is in operation (that is, rotating). The outer diameter of the helical blade 180 may be smaller than the inner diameter of the tube 172. The outer diameter of the helical blade 180 may be about 5%, about 10%, about 20%, about 25%, about 33%, or about 50% smaller than the inner diameter of the tube 172. In a preferred embodiment, the outer diameter of the helical blade 180 may be about 33% smaller than the inner diameter of the tube. In one example, the diameter of the tube 172 may have a diameter of 3 inches and the auger 178 may have a diameter of 2 inches. In one example, the auger 178 does not contact the conveyor tube 172, but instead the auger 178 is floated or centered in the tube 172. Therefore, there is no friction between the auger 178 and the inside of the tube 172. The clearance between the blade 180 and an inner surface of the tube 172 may allow the auger 178 to rotate freely within the tube 172 without contacting the inner surface of the tube 172 or without feed between the auger blade and the tube inner surface causing the auger to bind or causing excessive friction that can load the motor and result in premature power drain.

The auger 178 may be affixed within the central axis of the conveyer tube 172 such that the axis of the auger 178 extends from the feed ingress aperture 174 to the dispense opening 186. As shown in FIGS. 2 and 4, one end of auger 178 is rotatably secured to the base housing 140 via an auger shaft end support 182 spanning the dispense opening 186 of the feed conveyor tube 172.

Feed dispense system 170 may include an electric conveyer motor 200 mounted, e.g., on a motor support 206, within the base housing 140 and operatively coupled, e.g., by a shaft coupler 210, to the auger 178, a programmable motor controller 202, which may be a timer, and a power source, such as a battery 204 (e.g., 13 amps). Auger shaft 179 extends through one end of the feed conveyor tube 172 and is directly or indirectly coupled to the motor 200 for effecting powered rotation of the auger 178.

The base housing 140 may include a removable access panel to permit access to the auger 178, coupler 210, motor 200, controller 202, battery 204, and/or support 206.

Conveyor motor 200 may be an electric slow rotation speed motor, such as, for example, a 12 volt gear reduction motor operated at a speed in the range of 10 to 30 rpm (e.g., 20 rpm) with an 8 mm shaft., and is connected to power source, such as battery 204 disposed within the base housing 140 or other, remote power source, or to an electrical outlet (if available) or a generator (if not disruptive to the wildlife). In some embodiments, the conveyor motor 200 and battery 204 may be located inside of the ground-anchored base 140. In some embodiments, the programmable controller 202 and battery 204 may be located inside the feed hopper 100.

Programable controller 202 may be or include a timer provided to activate conveyor motor 200 at set time intervals, e.g., hourly, every X hours, once or twice daily, etc., to rotate the auger 178 to move feed through the feed conveyor tube 172 to the dispense opening 186 at the programmed intervals. In one example, the controller 202 is programmed to activate the motor up to six times per 24 hour cycle, for up to 30 seconds for each activation. In one example, controller 200 may include a receiver configured to receive motor activation/deactivation signals, e.g., wireless signals, transmitted from a remote control device, e.g., a smart phone application, to enable the motor 200 to be remotely activated and deactivated on demand. For example, where the operator becomes aware, e.g., via a trail camera, that the feed is being taken by undesirable animals, e.g., bears, the operator may interrupt the normal feed dispense intervals programmed into the controller 202, so that no feed is dispensed for a period of time and until the undesirable animals go away.

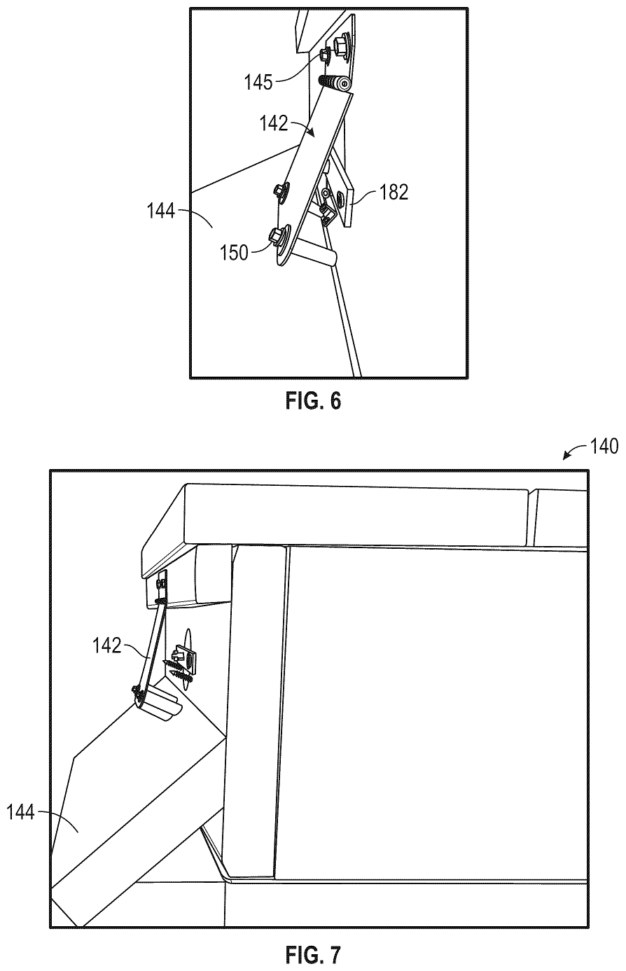

In some embodiments, and as shown in FIGS. 2, 5, 6, and 7, the feed dispense opening 186 may be protected or partially covered by a small animal restrictor 142. The small animal restrictor 142 may be secured to a front panel of the base housing 140 by fasteners 145, 150, such as a screws or bolts. The small animal restrictor 142 may comprise a plate anchored at its top edge against the front panel of the housing 140 by fasteners 145 and anchored at its bottom edge by spacer/fasteners 150 in a position spaced away from the front panel so that the plate is angled outwardly to allow for the passage of feed 52. A gap between the bottom edge of the plate and the front panel of the housing is preferably small enough to prevent or impede entry by small animals, such as squirrels, racoons, etc. into the feed dispense opening 186. The plate of the restrictor 142 may be spaced at its bottom edge from the font panel by about 1.0 to 2.5 inches, e.g., about 1.75 inches, and at its top edge by 0 inches (as shown in FIGS. 5 and 6) to about 0.5 to 1.5 inches, e.g., about 1.0 inch (as shown in FIGS. 2 and 7). As shown in FIG. 5, the plate may comprise a hinge with one portion or plate of the hinge secured by fasteners 145 directly the front panel of the housing 140 and another portion or plate of the hinge secured by fasteners 150 and spacers so as to be spaced apert from the front panel of the housing. The top and bottom spacing can be modified as needed depending on the size(s) of the animal(s) to be deterred.

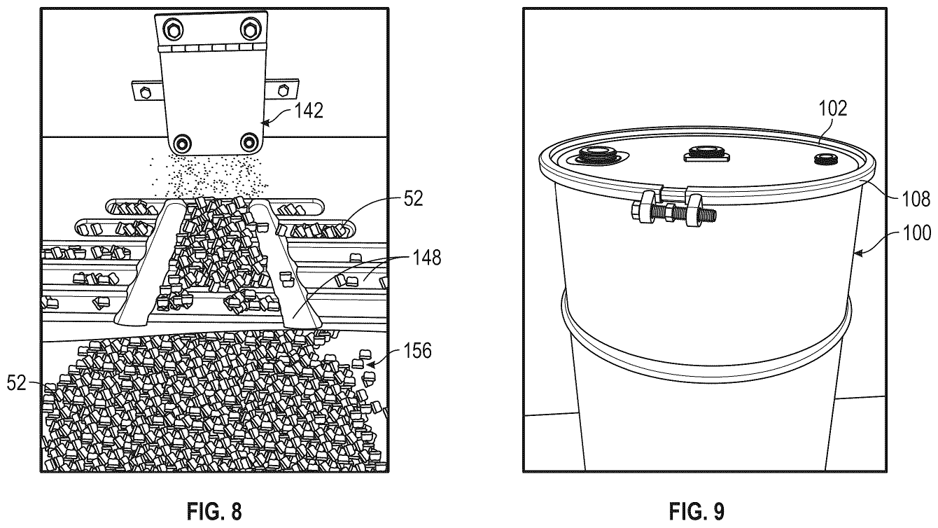

As shown in FIGS. 1, 2, and 7, feed presentation plate 144 may comprise an angled wall extending (e.g., at about 40 degrees or 45 degrees+/−15 degrees) from a front panel of base housing 140 beneath the feed dispense opening 186. In some embodiments, and as shown in FIG. 8, feed 52 dispensed from the feed dispense opening 186 may fall from behind the small animal restrictor142 and slide down the sloped feed presentation plate 144 at the front of the ground-anchored base 140. Presentation plate 144 may include physical features to help retain dispensed feed on the angled surface of the presentation plate, such as a raised riffle 146 along a bottom edge of the presentation plate (see FIG. 2) and/or grooves and slots 148 formed on a surface of the presentation plate (see FIG. 8). At least a portion of the feed 52 may be captured by the riffle 146 and/or slots 148 on the presentation plate 144. The angled orientation of the plate 144 ensures that it is visible by a trail camera or other video monitoring system. In other embodiments, presentation plate 144 may be oriented generally horizontally, extending transversely (e.g., perpendicularly) from the base housing 140.

In some embodiments, and as shown in FIG. 1, the base housing 140 may further comprise one or more additional presentation plates, such as a secondary feed presentation plate (“secondary plate”) 156. Such additional presentation plates, such as secondary plate 156, may be preferable where the ground drops off in front of the base housing 140 to capture most discharged feed 52 and prevent it from falling onto the ground.

An alternative version of the wildlife feeder is shown in FIG. 13. The wildlife feeder in FIG. 13 includes a housing 140 with a feed presentation plate 144 and a secondary feed presentation plate 156 as described above. The housing 140 includes sidewalls 160 on opposite sides of the primary presentation plate 144 and a top cover 162 extending across the side walls 160 and to the front face of the housing 140. The cover 162 protects the presentation plate 144 from rain and snow, which can potentially impede feed 52 from sliding down the presentation plate. Side walls 158 may be also provided on opposite sides of the secondary presentation plate 156, which together with the raised riffle 146, form a catch box 164 to catch the flowable feed 52 falling from the presentation plate 144.

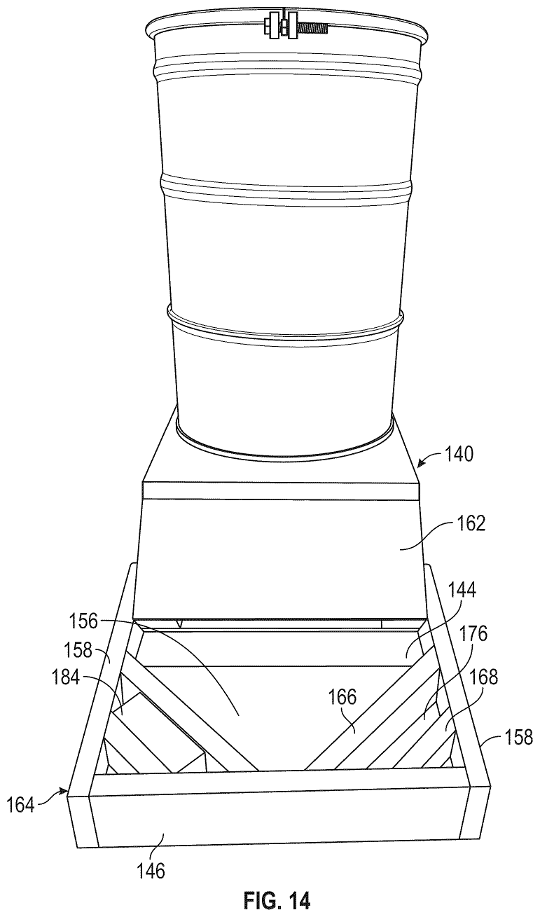

A second alternative version of the wildlife feeder is shown in FIG. 14. The wildlife feeder in FIG. 14 includes housing 140 with a cover 162, a feed presentation plate 156 (which may be a secondary fee presentation plate), and catch box 164 as described above. Feed presentation plate 156 may include recessed or raised riffles or other physical features (not shown) to retain the feed on the slopped surface and to visually display a portion of the feed dispensed. One or more divider walls within the catch box form one or more secondary feed compartments. For example, as shown in FIG. 14, parallel divider walls 166 and 168 extending diagonally across one or both lower corners of the catch box 164 form secondary feed compartments 176. Feed compartment(s) 176 may hold a secondary feed, which may be a non-flowable feed, such as a salt block 184 or the like. Alternatively, a single divider wall 166 extending diagonally across one or both lower corners of the catch box 164 can be installed to form triangular-shaped secondary feed compartment(s) in the corners of the catch box 164.

All possible combinations of elements and components described in the specification or recited in the claims are contemplated and considered to be part of this disclosure. It should be appreciated that all combinations of the foregoing concepts and additional concepts discussed in greater detail herein (provided such concepts are not mutually inconsistent) are contemplated as being part of the inventive subject matter described herein. In particular, all combinations of claimed subject matter appearing at the end of this disclosure are contemplated as being part of the inventive subject matter disclosed herein.

While the subject matter of this disclosure has been described and shown in considerable detail with reference to certain illustrative examples, including various combinations and sub-combinations of features, those skilled in the art will readily appreciate other embodiments and variations and modifications thereof as encompassed within the scope of the present disclosure. Moreover, the descriptions of such examples, combinations, and sub-combinations is not intended to convey that the claimed subject matter requires features or combinations of features other than those expressly recited in the claims. Accordingly, the scope of this disclosure is intended to include all modifications and variations encompassed within the scope of the following appended claims.

What is claimed is:

1. A tamper-resistant wildlife feeder comprising:
a base housing;
anchor means operable with the base housing for anchoring the base housing to a surface supporting the wildlife feeder;
a feed hopper for storing a supply of flowable wildlife feed, wherein the feed hopper is supported on the base housing and includes a feed egress aperture at a bottom end of the feed hopper;
securing means for securing the feed hopper to an immovable object in close proximity to the wildlife feeder;
a feed dispense system comprising:
a feed conveyor tube disposed within the base housing and having feed ingress aperture positioned with respect to the feed egress aperture of the feed hopper to allow flowable wildlife feed to flow from the feed hopper into the feed conveyor tube, wherein the feed conveyor tube terminates at a feed dispense opening formed in a wall of the base housing; and
an auger disposed within the feed conveyor tube and configured to convey feed within the feed conveyor tube from the feed ingress aperture to the feed dispense opening;
a feed presentation plate positioned to receive feed dispensed from the feed dispense opening and configured to hold at least a portion of the dispensed feed in a manner to enable wildlife to eat the feed supported on the feed presentation plate; and
a small animal restrictor positioned over the feed dispense opening and configured to restrict small animal access to the feed dispense opening and the feed conveyor tube.

2. The wildlife feeder of claim 1, wherein the feed hopper comprises a funnel-shaped floor terminating in said feed egress aperture.

3. The wildlife feeder of claim 1, wherein the feed presentation plate comprises a raised riffle and/or grooves or slots formed in a top surface thereof.

4. The wildlife feeder of claim 1, further comprising a secondary feed presentation plate disposed with respect to the feed presentation plate to receive feed flowing from the feed presentation plate.

5. The wildlife feeder of claim 4, comprising side walls and a raised riffle secured to the secondary plate to form a catch box to capture discharged feed.

6. The wildlife feeder of claim 1, wherein the immovable object is a tree, fence post, utility pole, or metal post.

7. The wildlife feeder of claim 1, wherein the securing means comprise clamps, screws, and/or steel straps.

8. The wildlife feeder of claim 1, wherein the feed dispense system further comprises a conveyor motor connected to a power source and coupled to the auger so that the auger is driven by the conveyer motor.

9. The wildlife feeder of claim 8, wherein the feed dispense system further comprises a programmable controller in communication with the conveyor motor and programmed to activate the conveyor motor at programmed time intervals.

10. The wildlife feeder of claim 8, wherein the power source comprises a battery.

11. The wildlife feeder of claim 1, wherein the auger has a diameter that is less than a width of the feed conveyor tube.

12. The wildlife feeder of claim 1, wherein the auger diameter is about 33% smaller than a diameter of the feed conveyer tube.

13. The wildlife feeder of claim 11, wherein the auger is substantially centered in the feed conveyor tube so there is no contact between a blade of the auger and an inside surface of the feed conveyor tube.

14. The wildlife feeder of claim 1, wherein the anchor means comprises one or more stakes extending through a portion of the base housing or through an anchor beam to which the base housing is attached and into the surface supporting the wildlife feeder and/or one or more weights positioned on a portion of the base housing and/or the feed hopper.

15. The wildlife feeder of claim 1, wherein the feed presentation plate is angled.

16. The wildlife feeder of claim 1, wherein the small animal restrictor comprises a plate secured to the wall of the base housing in a position over the feed dispense opening.

17. The wildlife feeder of claim 16, wherein one edge of the plate of the small animal restrictor is in contact with the wall to which the plate is secured and an opposite edge of the plate is spaced apart from the wall.

18. The wildlife feeder of claim 5 comprising one or more divider walls mounted within the catch box to form one or more secondary feed compartments within the catch box.

19. The wildlife feeder of claim 1, further comprising:
a lid disposed on the hopper; and
a ring clamp securing the lid to the hopper.

20. The wildlife feeder of claim 1, further comprising a top cover extending from the base housing at a position above the feed dispense opening.
